(19) United States
(12) Patent Application Publication
(10) Pub. No.: US 2002/0147934 A1
(43) Pub. Date: Oct. 10, 2002

(54) Power selection system for use with a reconfigurable circuit and method of operating the same

(76) Inventor: Anil Kavipurapu, Emmaus, PA (US)

Correspondence Address: Glenn W. Boisbrun, Hitt Gaines & Boisbrun, P.C., P.O. Box 832570, Richardson, TX, 75083, US

(21) Appl. No.: 09/826,240

(22) Filed: Apr. 4, 2001

(51) Int. Cl. G06F 1/26; G06F 1/28; G06F 1/30

(52) U.S. Cl. 713/323

(57) ABSTRACT

A power selection system for use with a reconfigurable circuit and a method of operating the same. In one embodiment, the power selection system includes a monitoring circuit that monitors an operating characteristic associated with at least one node located within the reconfigurable circuit. The power selection system also includes a mode selection circuit, coupled to the monitoring circuit, that selects a mode of operation for the reconfigurable circuit. The mode selection circuit selects a normal power mode when the operating characteristic falls within a predetermined operating range of the reconfigurable circuit. The mode selection circuit selects an alternative power mode when the operating characteristic falls outside of the predetermined operating range of the reconfigurable circuit.

### TECHNICAL FIELD OF THE INVENTION

The present invention is directed, in general, to electronic circuits and, more specifically, to a power selection system for use with a reconfigurable circuit and a method of operating the same.

### BACKGROUND OF THE INVENTION

A reconfigurable circuit, such as a reconfigurable digital filter or a reconfigurable digital Pseudo Random Binary Sequence (PRBS) generator, is a circuit (perhaps with analog components), that has certain relevant digital design characteristics that are designed to be revocably modifiable at the direction of a client.

An example of the use of a reconfigurable circuit is disclosed in U.S. Pat. No. 5,719,326, entitled “Reconfigurable Filter System,” by Vulith, et al. (“Vulith”), issued on Feb. 17, 1998, which is incorporated herein by reference in its entirety. Vulith discloses an integrated circuit (IC), either digital or analog, which may be configured as a high pass band filter, a low pass band filter, notch filter, or the filtering function may simply be disabled. As may be discerned by the reference, a reconfigurable circuit can be advantageously adapted to meet a variety of a client's needs.

A problem arising from the use of electronic circuits (e.g., digital circuits) in general is ascertaining and controlling the power consumption of the digital circuit and its associated sub-circuits. At least in part, digital circuits consume power as a function of their usage. Moreover, the power demands of a reconfigurable, digital circuit may vary substantially as the configuration of the circuit changes. A digital circuit could by made low power or fixed power by design, but once designed in such a manner, the inflexibility of the design cannot accommodate multiple power modes of operation. Thus, the digital circuit is constrained to a power consumption range, which may confine a range of reconfigurations available to an end user.

One approach that can be used for power control in a digital system is disclosed by U.S. Pat. No. RE 36,839, entitled “Method and Apparatus for Reducing Power Consumption in Digital Electronic Circuits,” by Simmons, et al. (“Simmons”), issued on Aug. 29, 2000, which is incorporated herein by reference in its entirety. Simmons discloses a “clock gating” system for turning on and off certain functional blocks in a circuit or system. In Simmons, the clock power conservation system also has a control line associated with the given functional block and its functional block “neighbor” to provide control signals to a clock controller to determine and optimize future power usage by the various functional blocks by turning on and off the various functional blocks.

As demonstrated by the reference, the use of a “clock gating” system with a power conservation system adds a layer of complexity to the circuit and further challenges to the design process. Also, clock-gating type systems typically only lend themselves to responding with an “on-off” response, or instigating a previously defined level of power utilization, which leads to a corresponding lack of flexibility.

Microcontrollers can also be used as a subsystem or subsystems of a power conservation system, both in gate-clocked and non gate-clocked systems. U.S. Pat. No. 5,481,730, entitled “Monitoring and Control of Power Supply Functions using a Microcontroller”, Brown, et al. (“Brown”), issued on Jan. 2, 1996, which is incorporated herein by reference in its entirety, discloses, a power supply monitoring and control circuit using a microcontroller to remotely monitor and control the functions and conditions of a power supply. For a reconfigurable digital circuit, however, microcontroller intervention during operation, such as in a gated system, makes the overlying software more complex. Also, the microcontroller requires discrete components associated with both the digital circuit and the microcontroller, instead of having some form of embedded system associated with the digital circuit. Moreover, such microcontroller based systems typically do not closely monitor the internal nodes associated with the digital circuit.

Accordingly, what is needed in the art is a system and method employable with a reconfigurable circuit that may dynamically control the power utilization associated therewith.

### SUMMARY OF THE INVENTION

To address the above-discussed deficiencies of the prior art, the present invention provides a power selection system for use with a reconfigurable circuit and a method of operating the same. In one embodiment, the power selection system includes a monitoring circuit that monitors an operating characteristic associated with at least one node located within the reconfigurable circuit. The power selection system also includes a mode selection circuit, coupled to the monitoring circuit, that selects a mode of operation for the reconfigurable circuit. The mode selection circuit selects a normal power mode when the operating characteristic falls within a predetermined operating range of the reconfigurable circuit. The mode selection circuit selects an alternative power mode when the operating characteristic falls outside of the predetermined operating range of the reconfigurable circuit.

### BRIEF DESCRIPTION OF THE DRAWINGS

For a more complete understanding of the present invention, reference is now made to the following descriptions taken in conjunction with the accompanying drawings, in which:

FIG. 1 illustrates a schematic diagram of an embodiment of a reconfigurable circuit including a power selection system constructed according to the principles of the present invention; and

FIG. 2 illustrates a schematic diagram of an embodiment of a power selection system constructed according to the principles of the present invention.

### DETAILED DESCRIPTION

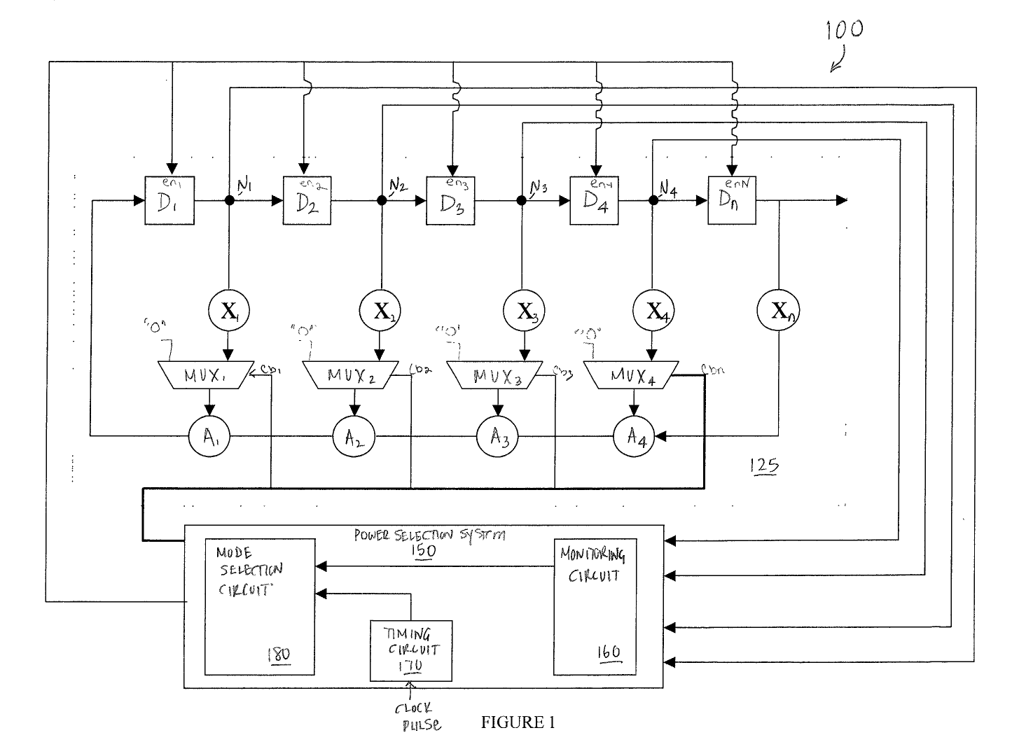

Referring initially to FIG. 1, illustrated is a schematic diagram of an embodiment of a reconfigurable circuit 100 including a power selection system 150 constructed according to the principles of the present invention. In the illustrated embodiment, the reconfigurable circuit 100 includes a monitored sub-circuit [e.g., a reconfigurable pseudo random binary sequence (PRBS) generator] 125. As in known to those skilled in the art, the PRBS generator 125 may be employed in a multitude of applications. One such application includes testing communications circuits or systems or to test error rates in a communication channel, especially, if there may be a long string of zeroes in the test data. Of course, any reconfigurable circuit such as filter circuits may be employed in accordance with the principles of the present invention.

An illustration of the operation of a PRBS generator 125 is set forth below. The PRBS generator's various binary numbers are input into one of a plurality of delay elements (generally designated D). After each cycle, the binary number is shifted into the next serial delay element D and into one of a plurality multipliers (generally designated “X”). In one embodiment of the present invention, the values of X may all have a similar value of “1”, which may also be known to those skilled in the art as “unity.”

Once the multiplication performed by a multiplier X has occurred, the value of this calculation is input into a multiplexer (generally designated MUX), except for the last multiplier Xn, which inputs directly into an adder (generally designated A). Ones of the multiplexers MUXs will either select the value from the tap of the multiplier X as an input and then pass this value on as its output, or the multiplexer MUX will select a ground value GND (i.e., a logical ‘zero’) and pass this value on as its output.

The selection of an output signal by the multiplexer MUX is determined by a value of a reference (generally designated Cb). If the reference Cb has a logical one output, the tap is passed. If the reference Cb has a logical zero output, then the ground value is passed. The value of the reference Cb, and hence the enablement or disablement of the multiplexer X, is determined either by a client as a result of a particular application, or as a function of a mode (e.g., a low power mode) of the power selection system 150, as will be described in greater detail below.

In the PRBS generator 125, the output of each multiplexer MUX, (which is either the value of the binary value associated with a delay element D multiplied by a tap of the multiplier X, or the output of the ground value GND) is input into the corresponding binary adder A (e.g., an exclusive-or element). The second input into the adders A is the value of the last multiplier Xn or the sum of the last multiplier Xn and one of the adjacent adders A or a string of adjacent adders A. The output of one of the adders Al is then fed back into the delay elements D thereby forming a feedback loop for the PRBS generator 125.

A node or a plurality of nodes (perhaps one or more output nodes of one of the delay elements D, internally composed of field-effect transistors and of which are generally designated N) are monitored by a monitoring circuit 160 of the power selection system 150. In an exemplary embodiment, the monitoring circuit 160 continuously counts and stores the number of voltage switches on the nodes N associated with the delay elements D. The output from the monitoring circuit 160 is then employed by a mode selection circuit 180 of the power selection system 150.

When receiving a time pulse from a timing counter 170 of the power selection system 150, the mode selection circuit 180 either applies a “normal” power mode to the PRBS generator 125 if the mode selection circuit 180 determines that certain operating characteristics of the PRBS generator 125, (i.e., such as those operating characteristics manifested by the nodal switching count) fall within a predetermined range, or the mode selection circuit 180 will apply an “alternative” power mode. This “alternative” power mode may either be a higher power mode or a lower power mode, implemented through such methods as enabling or disabling a multiplexer MUX. The “alternative” power mode may also be implemented through other means, such as an “on-off” power mode that is associated with powering-down a delay element D. Thus, in instances wherein the operating characteristics are manifested by the nodal switching count, the predetermined operating range includes a threshold number of switching transitions. Additionally, it should be understood that the mode selection circuit 180 may embody a plurality of power modes and the selected mode being a function of the operating characteristic in comparison to a plurality of intermediate levels within the predetermined operating range.

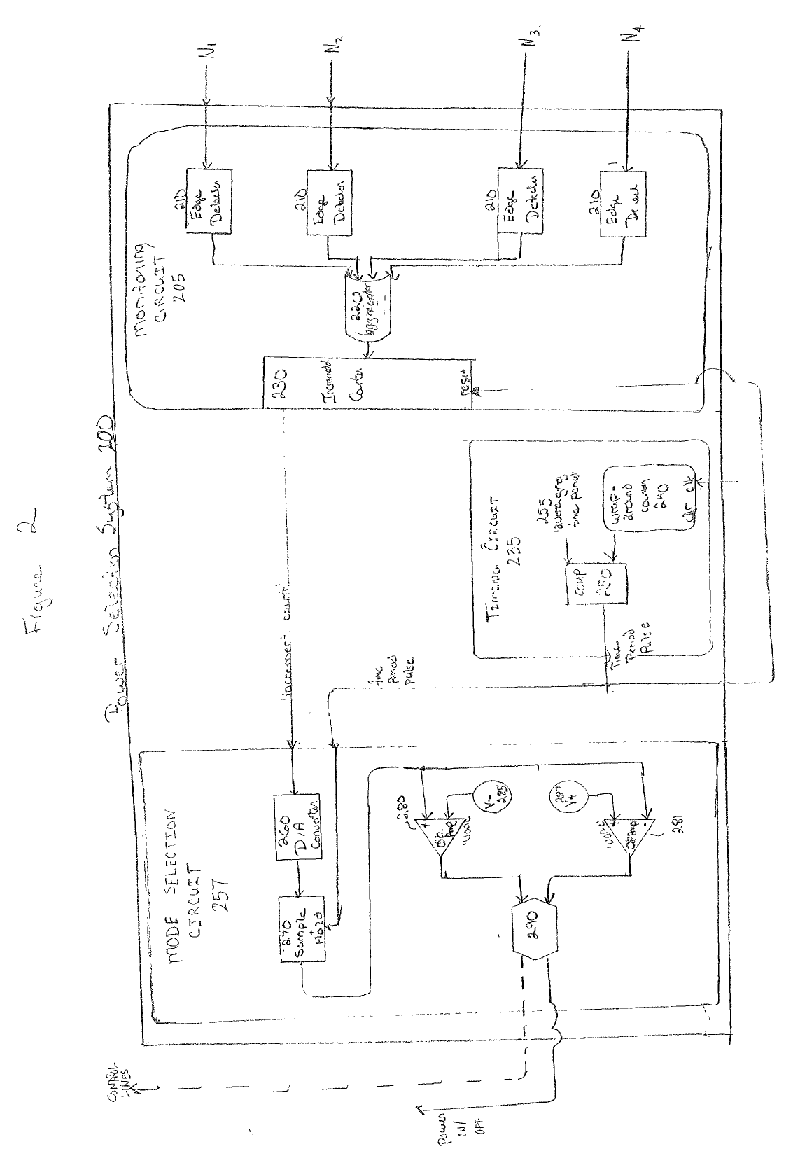

Turning now to FIG. 2, illustrated is a schematic diagram of an embodiment of a power selection system 200 constructed according to the principles of the present invention. The power selection system 200 includes a monitoring circuit 205, a timing circuit 235, and a mode selection circuit 257, each in turn with its own sub-circuits and functional blocks. These circuits and sub-circuits will now be described in more detail.

The monitoring circuit 205 in the illustrated embodiment utilizes edge detector circuits (one of which is designated 210). The edge detector circuits 210 discern operating characteristics such as voltage changes in monitored nodes associated with the delay elements D illustrated and described with respect to FIG. 1. If any monitored node either switches from a high voltage to a low voltage state, or if the monitored node switches from a low voltage to a high voltage state, then the associated edge detector circuit 210 is triggered and signals an aggregator 220 of this occurrence.

An output of the aggregator 220 may be a function of the sum of all the outputs from the edge detector circuits 210 at any given time. The output of the aggregator 220 is then read by a switching counter or an incremental counter 230. A value of a stored memory of the incremental counter 230 may then be increased by a function of the output of the aggregator 220. An output of incremental counter 230 is then utilized by the mode selection circuit 257 as will be explained below. After a predetermined interval, the value of the incremental counter 230 will then be reset to the value of “zero” by the timing circuit 235.

The timing circuit 235 includes a “wrap-around” counter 240 and a comparator 250. An input clock signal is supplied to the wrap-around counter 240. The wrap-around counter 240 outputs a signal representing the number of clock cycles received over a given time period. This output value is then input into the comparator 250, which compares this value to a control input predetermined value, the “averaging time period” 255. The values of both the output of the wrap-around counter 240 and the averaging time period 255, utilized by the comparator 250, represent a given time period. If the value representation of the number of clock cycles output by the wrap-around counter 240 equals or exceeds the control value given by the averaging time period 255, a logical “high” state is signaled by the output of the comparator 250. This logical “high” state is referred to as a “time period pulse”, and is utilized by the mode selection circuit 257 as detailed below. The time period pulse also triggers the reset of the incremental counter 230 of the monitoring circuit 205, as mentioned above. A reset of the incremental counter 230 memory is necessary to begin an accurate measure of the number of nodal switches in any given time period. Thus, the monitoring circuit 205 may monitor an operational characteristic for a period of time and the mode selection circuit 257 selects the mode of operation of the monitored circuit by comparing a predetermined operating range to the operational characteristic over the specified time period.

The mode selection circuit 257 includes a digital-to-analog converter 260, a sample-and-hold circuit 270, first and second operational amplifiers 280, 281, a low voltage reference 285, a high voltage reference 287,and a selection sub-circuit 290, such as a sub-circuit which may utilize a look-up table to determine an appropriate selection sub-circuit 290 output value. A digital output from the monitoring circuit 205, representing the amount of nodal switching activity of the monitored nodes, is converted to an analog voltage signal by the digital-to-analog converter 260. This analog voltage signal is then input into the sample-and-hold circuit 270.

The sample-and-hold circuit 270 samples the analog voltage reading when receiving a time period pulse from the timing counter 235. The sample-and-hold circuit 270 then continues to output this value to the operational amplifiers 280, 281, configured as voltage comparators (hereby referred to as “voltage comparator operational amplifiers”), and will continue to output this value until the next time period pulse.

The sample and hold procedure is done to ensure that the voltage comparator operational amplifiers 280, 281 are responding only to the number of nodal switches at the end of any given time period represented by the time period pulse. Otherwise, the voltage comparator operational amplifiers 280, 281 would be responding to the number of nodal switches recorded at any intermediate time by the monitoring circuit 205. This intermediate sampling would disrupt the utility of the mode selection circuit 257.

Both of the voltage comparator operational amplifiers 280, 281 have the same input voltage from the output of the sample-and-hold circuit 270, representing the aggregate number of nodal switches recorded for at any given time period pulse. The first voltage comparator operational amplifier 280 has the sample-and-hold circuit's 270 voltage connected to its non-inverting input. The voltage comparator operational amplifier 280 has its inverting input connected to the low voltage reference 285. The low voltage reference 285 represents the lowest level of acceptable nodal switches. If the first voltage comparator operational amplifiers 280 determines that low voltage reference 285 is less than the non-inverting input voltage, the voltage comparator operational amplifier 280 will output a positive voltage that is equal to the positive rail thereof. Otherwise, the voltage comparator operational amplifier 280 will output a negative voltage that is equal to the negative voltage rail thereof. This is the low-switching node sensor. The lower rail voltage output means an unacceptably low number of node voltage switch transitions have occurred whereas a high rail voltage output signifies that the number of monitored node transitions is not less than the certain predetermined amount of transitions represented by the low voltage reference 285.

The second voltage comparator operational amplifier 281 has its inverted input connected to the analog voltage output of the Sample-and-hold circuit 270, and the non-inverting input is connected to the high voltage reference 287. The high voltage reference 287 represents the highest level of acceptable nodal switches. If the second voltage comparator operational amplifier 281 determines that the high voltage reference 287 is greater than the inverting input voltage, the second voltage comparator operational amplifier 281 will output a voltage that is equal to the positive rail of the second voltage comparator operational amplifier 281. Otherwise, the second voltage comparator operational amplifier 281 will output a voltage that is equal to the negative rail of the second voltage comparator operational amplifier 281. The second voltage comparator operational amplifier 281 is the high-switching node sensor. A lower rail voltage output means an unacceptably high number of node voltage switch transitions has occurred whereas a high rail voltage means that the number of transitions is not greater than the certain predetermined amount of transitions represented by the high voltage reference 287.

The high rail and low rail voltage outputs of the voltage comparator operational amplifier 280, 281 are connected to the selection sub-circuit 290. The selection sub-circuit 290 reads the voltages to determine the acceptability of the node switch rate. If both signals are positive, the selection sub-circuit 290 does not alter the power characteristics applied to the delay elements D, nor does the selection sub-circuit 290 alter the enablements of the multiplexers MUXs using the reference Cb control lines as illustrated and described with respect to FIG. 1.

However, if either of the voltage comparator operational amplifiers 280, 281 has a negative voltage, the selection sub-circuit 290 will alternatively power down any delay element D or any group thereof and/or selectively enable or disable various multiplexers MUXs through the use of the enabling or disenabling the reference inputs Cb as described with respect to FIG. 1. The direct power-up or power-down of the delay elements D, the selective enablement or disablement of the multiplexers MUXs, or reconfiguration signal transmitted to any portion of a reconfigurable circuit is a final step in which the power selection system 200 selects the power level for any given time period pulse.

Thus, the present invention provides a power selection circuit that monitors a characteristic associated with a reconfigurable circuit and selects a mode of operation based thereon. In an embodiment described above, the mode selection circuit selects the normal power mode when the number of switching transitions is less than or equal to the threshold number of switching transitions, and the alternative power mode when the number of switching transitions is greater than the threshold number of switching transitions. Of course, other parameters and control techniques may be monitored and applied in accordance with the principles of the present invention.

Thus, the present invention may take advantage of the fact that power consumption in a digital circuit is directly related to the frequency of switching of its internal nodes. By monitoring these nodes within the reconfigurable circuit, the power selection circuit takes advantage of operational information readily available and adapts the reconfigurable circuit for different modes of operation. As a result, the flexibility of the reconfigurable circuit is further enhanced to accommodate a multitude of applications. Additionally, the power selection circuit of the present invention may accomplish its intended purpose without employing complex external circuitry such as a microcontroller.

It should be understood, that the embodiments of the power selection system and reconfigurable circuits illustrated and described with respect to the preceding FIGUREs are submitted for illustrative purposes only and other configurations compatible with the principles of the present invention may be employed as the application dictates. Also, it should be understood that the systems associated with the present invention may be embodied in software, dedicated or hardwired discrete or integrated circuitry, or combinations thereof.

For a better understanding of reconfigurable circuits (such as PRBSs) and the applications therefor, in general, see Digital Communication, by Edward A. Lee and David G. Messerschmitt, Kluwer Academic Publishers, 2nd Ed, 1994.

Although the present invention and its advantages have been described in detail, those skilled in the art should understand that they can make various changes, substitutions and alterations herein without departing from the spirit and scope of the invention in its broadest form.

What is claimed is:

1. A power selection system for use with a reconfigurable circuit, comprising:
a monitoring circuit configured to monitor an operating characteristic associated with at least one node located within said reconfigurable circuit; and
a mode selection circuit coupled to said monitoring circuit and configured to select one of:
a normal power mode when said operating characteristic falls within a predetermined operating range of said reconfigurable circuit, and
an alternative power mode when said operating characteristic falls outside of said predetermined operating range of said reconfigurable circuit.

2. The power selection system as recited in claim 1 wherein said monitoring circuit comprises a switching counter configured to monitor a number of switching transitions associated with said at least one node located within said reconfigurable circuit.

3. The power selection system as recited in claim 2 wherein said predetermined operating range comprises a threshold number of switching transitions.

4. The power selection system as recited in claim 3 wherein said mode selection circuit is configured to select one of:
said normal power mode when said number of switching transitions is less than or equal to said threshold number of switching transitions, and
said alternative power mode when said number of switching transitions is greater than said threshold number of switching transitions.

5. The power selection system as recited in claim 1 further comprising a timing counter configured to track a period of operation of said reconfigurable circuit.

6. The power selection system as recited in claim 1 wherein said alternative power mode is a low power mode.

7. The power selection system as recited in claim 1 wherein said reconfigurable circuit comprises a Pseudo Random Binary Sequence (PRBS) generator.

8. A method of operating a reconfigurable circuit, comprising:
monitoring an operating characteristic associated with at least one node located within said reconfigurable circuit; and
selecting one of:
a normal power mode when said operating characteristic falls within a predetermined operating range of said reconfigurable circuit, and
an alternative power mode when said operating characteristic falls outside of said predetermined operating range of said reconfigurable circuit.

9. The method as recited in claim 8 wherein said monitoring comprises monitoring a number of switching transitions associated with said at least one node located within said reconfigurable circuit.

10. The method as recited in claim 9 wherein said predetermined operating range comprises a threshold number of switching transitions.

11. The method as recited in claim 10 wherein said selecting comprises selecting one of:
said normal power mode when said number of switching transitions is less than or equal to said threshold number of switching transitions, and
said alternative power mode when said number of switching transitions is greater than said threshold number of switching transitions.

12. The method as recited in claim 8 further comprising tracking a period of operation of said reconfigurable circuit.

13. The method as recited in claim 8 wherein said reconfigurable circuit comprises a Pseudo Random Binary Sequence (PRBS) generator.

14. A reconfigurable circuit, comprising:
a monitored sub-circuit, including:
a delay element, associated with a node of said reconfigurable circuit, having a switch;
a multiplier interposed between said node and an output of said reconfigurable circuit; and
a power selection system, including:
a monitoring circuit that monitors an operating characteristic associated with said node, and
a mode selection circuit, coupled to said monitoring circuit, that selects one of:
a normal power mode when said operating characteristic falls within a predetermined operating range of said reconfigurable circuit, and
an alternative power mode when said operating characteristic falls outside of said predetermined operating range of said reconfigurable circuit.

15. The reconfigurable circuit as recited in claim 14 wherein said monitored sub-circuit comprises a plurality of delay elements, associated with a respective node of said reconfigurable circuit, having a corresponding switch and a plurality of multipliers interposed between said one of said nodes and said output of said reconfigurable circuit, said monitoring circuit monitoring an operating characteristic associated with at least one of said nodes.

16. The reconfigurable circuit as recited in claim 14 wherein said monitoring circuit comprises a switching counter that monitors a number of switching transitions associated with said switch associated with said node.

17. The reconfigurable circuit as recited in claim 16 wherein said predetermined operating range comprises a threshold number of switching transitions.

18. The reconfigurable circuit as recited in claim 17 wherein said mode selection circuit selects one of:
said normal power mode when said number of switching transitions is less than or equal to said threshold number of switching transitions, and
said alternative power mode when said number of switching transitions is greater than said threshold number of switching transitions.

19. The reconfigurable circuit as recited in claim 14 wherein said power selection system further comprises a timing counter that tracks a period of operation of said monitored sub-circuit.

20. The reconfigurable circuit as recited in claim 14 wherein said monitored sub-circuit is selected from the group consisting of:
a Pseudo Random Binary Sequence (PRBS) generator, and
a filter circuit.
